(19) United States
(12) Patent Application Publication
(10) Pub. No.: US 2020/0398493 A1
(43) Pub. Date: Dec. 24, 2020

(54) SYSTEMS AND METHODS FOR 3D PRINTING USING A CORRECTION LAYER

(71) Applicant: AVANA TECHNOLOGIES, INC., Westborough, MA (US)

(72) Inventor: Caleb Hopkins YOUNG, Allston, MA (US)

(73) Assignee: AVANA TECHNOLOGIES, INC., Westborough, MA (US)

(21) Appl. No.: 16/905,650

(22) Filed: Jun. 18, 2020

Related U.S. Application Data
(60) Provisional application No. 62/863,369, filed on Jun. 19, 2019.

(51) Int. Cl. B29C 64/393; B33Y 40/20; B33Y 50/02

(52) U.S. Cl. CPC B29C 64/393; B29C 64/106; B33Y 50/02; B33Y 40/20

(57) ABSTRACT

A technical solution for determining and applying a correction layer to a three dimensional (3D) object undergoing a 3D printing process is described. The system can include an emitter device, a receiver device, and a 3D printer device. The emitter can illuminate a surface portion of an object, and a receiver device can receive a light input reflected from the surface portion of the object. The 3D printer device can create a profile for the surface portion of the object using an angle of incidence and an image received from the receiver device, and determine a difference between the profile and the specification of the object. The 3D printer device can generate instructions to apply a correction layer using the difference between the specification and the profile of the surface of the object.

### CROSS-REFERENCE TO RELATED APPLICATIONS

The present application claims the benefit of and priority to U.S. Provisional Patent Application No. 62/863,369, filed Jun. 19, 2019, and entitled “SYSTEMS AND METHODS FOR 3D PRINTING USING A CORRECTION LAYER”, the contents of which is incorporated herein by reference in its entirety.

### FIELD OF THE DISCLOSURE

This disclosure generally relates to three-dimensional (3D) printing, and to 3D printing using a one or more correction layers.

### BACKGROUND OF THE DISCLOSURE

In certain types of 3D printing (e.g., non-contact 3D printing such as inkjet 3D printing), errors may accrue as layers are printed, and if corrective measures are not taken, the errors may result in inaccurate 3D printed objects that do not match specifications.

### BRIEF SUMMARY OF THE DISCLOSURE

3D printing (also referred to as additive manufacturing) is a manufacturing technique in which a 3D object is constructed (e.g., based on a 3D model or specifications thereof). In some implementations, the object is created by successive layer depositions of a material such as a liquid or gel that can be cured or otherwise solidified to construct the object. In some implementations, subtractive processes, such as machining, cutting, drilling, and grinding typically are not used, and an object meeting specifications can be produced via selective layer deposition. 3D printing can be carried out using a device referred to as a 3D printer, which can contain “ink” corresponding to the material used for the successive layer depositions as well as components used to successively deposit layers of the ink to build 3D objects.

3D printing may involve a buildup of layers via successive deposition of layers, and errors in the object may accrue during the buildup. For example, the 3D printer may have a systemic error (or other type of error) that leads to an unevenness in a surface that is supposed to be even, according to specifications. This may occur, for example, if the 3D printer deposits too much or too little ink (the term “ink” is used herein to refer to material used for the successive layer depositions in 3D printing, and is not limited to traditional printer ink) in a particular area on each pass (on each layer deposition). This may result in the particular area being built up more than desired, or not being built up as much as desired. The error may compound during the buildup if the error applies to each pass of the 3D printer, ad may result in an undesirably uneven surface on the 3D printed object, or may result in some other undesired deviation form specifications for the 3D printed object.

Some comparative techniques for dealing with such issues involve using a roller to flatten an uneven 3D printed object. However, this can be time consuming and may interrupt the 3D printing process, and can significantly slow throughput of the 3D printer. Some other comparative techniques involve printing a correction layer for the 3D printed object using optical coherence tomography. In optical coherence tomography a surface of a 3D printer object is imaged, and complex algorithms are used to determine a correction layer for the 3D printed object to mitigate any detected errors. Optical coherence tomography can involve an expensive and precise configuration using a light source, a camera, polarizers, and other components discussed below in reference to FIG. 2.

To solve the foregoing issues, at least one aspect of this technical solution is generally directed to a system for determining and applying a correction layer to a three-dimensional (3D) object undergoing a 3D printing process. The system can include an emitter device configured to illuminate a surface portion of an object undergoing a 3D printing process. The system can include a receiver device configured to receive a light input reflected from the surface portion of the object and generate an image using the light input. The system can include a 3D printer device coupled to the emitter device and the receiver device and including one or more processors and a memory. The system can provide instructions to the emitter device to cause the emitter device to begin producing light at a first angle. The system can create a profile for the surface portion of the object using an angle of incidence and an image received from the receiver device. The system can determine a difference between a first point of the profile for the surface portion and a corresponding point in a specification of the object undergoing the 3D printing process. The system can generate instructions to apply a correction layer using the difference between the first point of the profile for the surface portion and the corresponding point in the specification of the object.

In some implementations, the system can emit light at the first angle. In some implementations, the system can receive instructions from the 3D printer device to emit light at a second angle. In some implementations, the system can emit light at the second angle in response to executing the instructions received from the 3D printer device. In some implementations, the system can receive instructions from the 3D printer device to emit light at a plurality of angles in a specified order. In some implementations, the system can emit light at the plurality of angles in the specified order in the instructions.

In some implementations, the system can emit light of a wavelength that is greater than the visible spectrum. In some implementations, the system can receive the light at the wavelength that is greater than the visible spectrum. In some implementations, the system can generate an analog signal in response to receiving the light input reflected from the surface portion of the object. In some implementations, the system can calculate an angle of incidence of the light reflected from the surface portion of the object using the analog signal. In some implementations, the system can provide the angle of incidence to the 3D printer device.

In some implementations, the system can include a photovoltaic element, and can receive an analog signal from the photovoltaic element. In some implementations, the system can calculate a height value of the surface portion of the object undergoing the 3D printing process using a distance between the emitter device and the receiver device. In some implementations, the system can create the profile of the surface portion of object using the height value.

In some implementations, the system can determine a vector between an illuminated point on the surface of the object and the receiver device. In some implementations, the system can generate the profile for the surface portion of the object using the vector. In some implementations, the system can detect a location of a laser line in the image received from the receiver device using a plurality columns of pixels in the image. In some implementations, the system can determine the angle of incidence relative to the receiver using the location of the laser line in the image received from the receiver device.

In some implementations, the system can determine that the height of a first point of the profile for the surface portion is less than a height of the corresponding point in the specification of the object. In some implementations, the system can generate the instructions to apply the correction layer such that the correction layer has a thickness that corresponds to the difference in the height of the first point and the height of the corresponding point.

At least one other aspect of the present disclosure includes a method of determining and applying a correction layer to a three-dimensional (3D) object undergoing a 3D printing process. The method can be performed, executed, or otherwise carried out, for example, by a 3D printer device comprising an emitter device and a receiver device. The method can include illuminating a surface portion of an object undergoing a 3D printing process. The method can include receiving a light input reflected from the surface portion of the object and generating an image using the light input. The method can include creating a profile for the surface portion of the object using an angle of incidence and the image. The method can include determining a difference between a first point of the profile for the surface portion and a corresponding point in a specification of the object undergoing the 3D printing process. The method can include generating instructions to apply a correction layer using the difference between the first point of the profile for the surface portion and the corresponding point in the specification of the object.

In some implementations, the method can include emitting, by the 3D printer device, light at the first angle. In some implementations, the method can include emitting light at the second angle in response to executing the instructions received from the 3D printer device. In some implementations, the method can include receiving instructions to emit light at a plurality of angles in a specified order. In some implementations, the method can include emitting light at the plurality of angles in the specified order in the instructions. In some implementations, the method can include emitting, by the 3D printer device, light of a wavelength that is greater than the visible spectrum. In some implementations, the method can include receiving light at the wavelength that is greater than the visible spectrum.

In some implementations, the method can include generating an analog signal in response to receiving the light input reflected from the surface portion of the object. In some implementations, the method can include calculating an angle of incidence of the light reflected from the surface portion of the object using the analog signal. In some implementations, the 3D printer device can further include a photovoltaic element, and the method can include receiving the analog signal from the photovoltaic element. In some implementations, the method can include calculating a height value of the surface portion of the object undergoing the 3D printing process using a distance between the emitter device and the receiver device; and

In some implementations, the method can include creating the profile of the surface portion of object using the height value. In some implementations, the method can include determining a vector between an illuminated point on the surface of the object and the receiver device of the 3D printer device. In some implementations, the method can include generating the profile for the surface portion of the object using the vector. In some implementations, the method can include detecting a location of a laser line in the image using a plurality columns of pixels in the image; In some implementations, the method can include determining the angle of incidence relative to the receiver device of the 3D printer device using the location of the laser line in the image.

In some implementations, the method can include determining that the height of a first point of the profile for the surface portion is less than a height of the corresponding point in the specification of the object. In some implementations, the method can include generating the instructions to apply the correction layer such that the correction layer has a thickness that corresponds to the difference in the height of the first point and the height of the corresponding point.

This disclosure provides systems and methods for determining a correction layer for a 3D printed object using a configuration that can be simpler and less expensive than optical coherence tomography. The systems and methods described herein can provide for more accurate 3D printed objects, and can be implemented efficiently and rapidly, thus making the systems and methods suitable for, amongst other implementations, quality control in automation lines that implement 3D printing. In some implementations the systems and methods described herein can provide for implementing correction layers in real-time during printing. The systems and methods described herein can correct errors in a 3D printing process before a repeated error accumulates to an irreparable degree (e.g. before 3D printing errors cause the 3D printed object to collapse under its own weight during printing). In some embodiments, the correction layers may be implemented as a final stage of a 3D printing process, and can provide for accurate 3D printed objects that match specifications.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising a client device in communication with a server device;

FIG. 1B is a block diagram depicting a cloud computing environment comprising a client device in communication with cloud service providers;

FIGS. 1C and 1D are block diagrams depicting embodiments of computing devices useful in connection with the methods and systems described herein.

FIG. 2 depicts error accruing during 3D printing.

FIG. 3 depicts a system for implementing optical coherence tomography to scan a 3D printed object.

FIG. 4A and FIG. 4B depict processing for optical coherence tomography for scanning a 3D printed object.

FIG. 5 depicts an overview of a system for applying a correction layer using laser line scanning.

FIG. 6 depicts an overview of a system for applying a correction layer using triangulation techniques.

FIG. 7 depicts an example embodiment of a system for applying a correction layer using triangulation techniques.

FIG. 8 depicts an example embodiment of a method for applying a correction layer using triangulation techniques.

FIG. 9A and FIG. 9B depict an overview of a system for applying a correction layer using parallax techniques.

FIG. 10 depicts an example embodiment of a system for applying a correction layer using parallax techniques.

FIG. 11 depicts an example embodiment of a method for applying a correction layer using parallax techniques.

FIG. 12 depicts an example embodiment of a quality control system.

FIG. 13A, FIG. 13B, and FIG. 13C depict an image of a laser on a 3D printed object, and a determined laser line location based on an analysis of the image.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes systems and methods for 3D printing using one or more correction layers.

### A. Computing and Network Environment

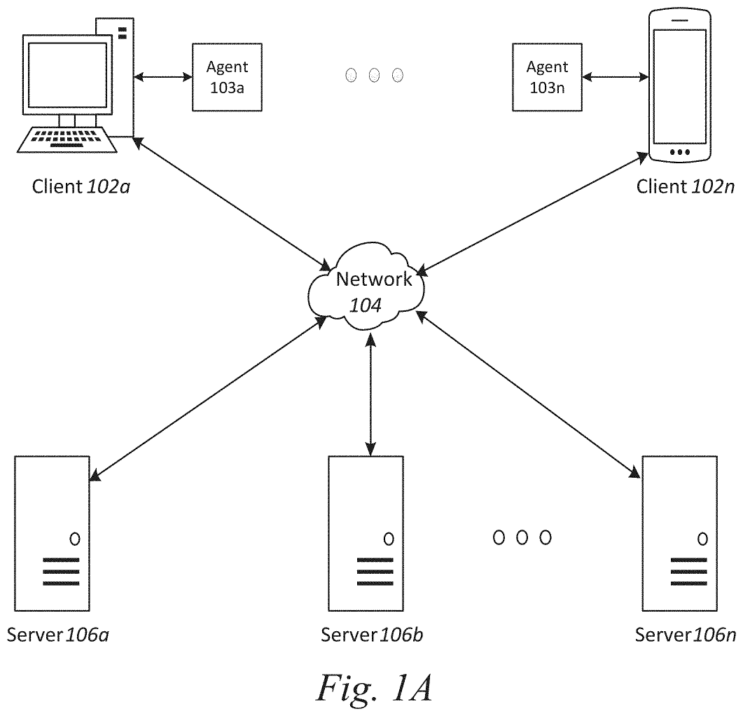

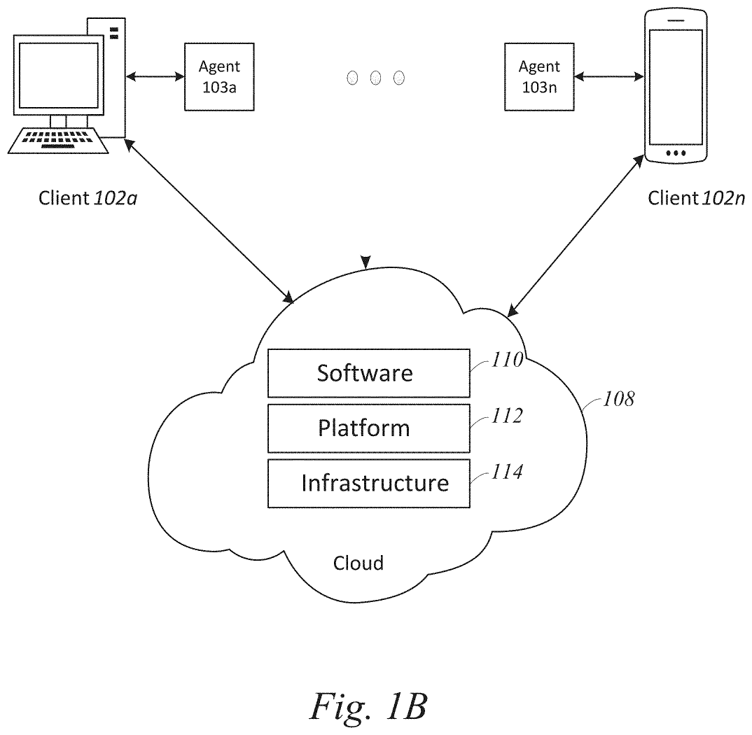

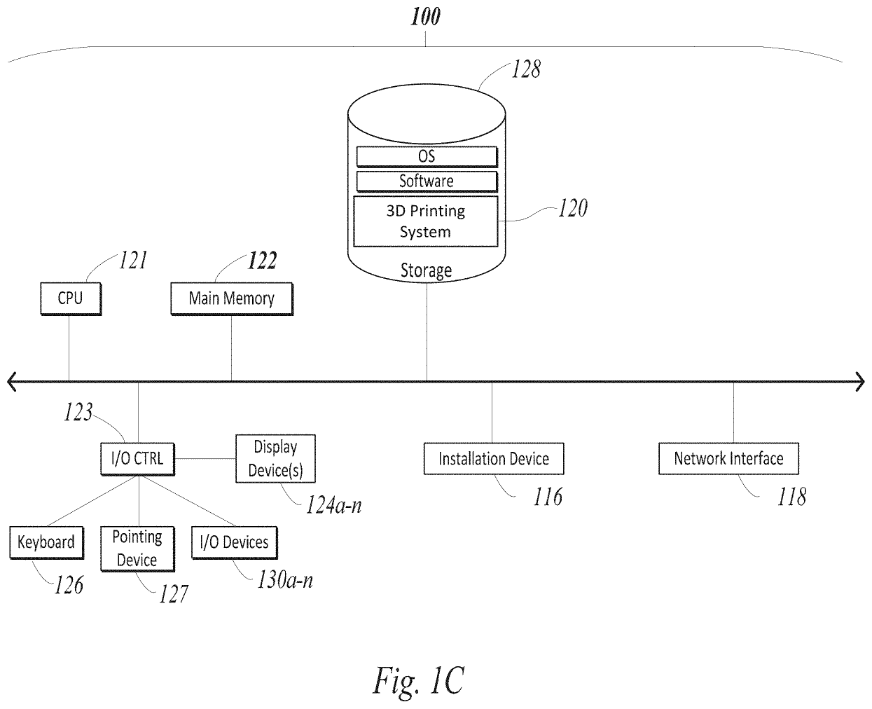

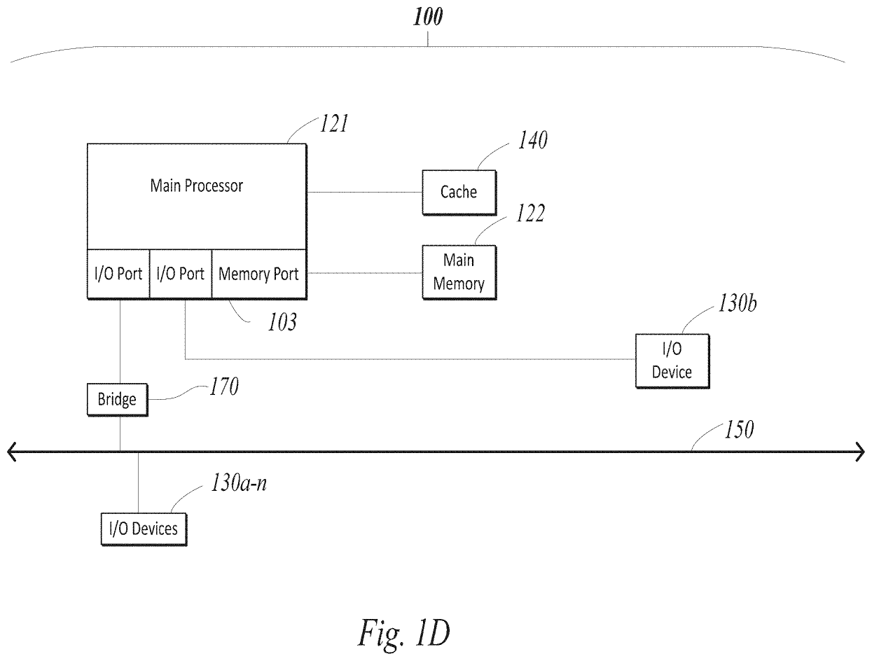

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more agents 103a-103n and one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 (not shown) or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with respective agents 103a-103n and with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a 3D printing system 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMID PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopic. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the 3D printing system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein.

In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, a PLAYSTATION 4, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, NINTENDO WII U, or a NINTENDO SWITCH device manufactured by Nintendo Co., Ltd., of Kyoto, Japan, an XBOX 360 or an XBOX ONE device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for 3D Printing Using One or More Correction Layers

This disclosure provides systems and methods for determining a correction layer for a 3D printed object, and which can provide for more accurate 3D printed objects, and can be implemented efficiently and rapidly, thus making the systems and methods suitable for, amongst other implementations, quality control in automation lines that implement 3D printing. The systems and methods disclosed herein can provide for implementing correction layers in real time during printing, before a repeated error accumulates to an irreparable degree. In some embodiments, the systems and methods disclosed herein implement a laser line scanner and a camera disposed at a predetermined distance from an emitter of the laser line scanner. Using techniques such as triangulation, a height of the 3D printed object can be determined, and a correction layer can be determined and implemented accordingly. In some embodiments, the systems and methods disclosed herein implement two receivers (e.g. two cameras) disposed at different positions, or a single receiver that is moved from a first position to a second position, and using techniques such as parallax analysis, a height of the 3D printed object can be determined, and a correction layer can be determined and implemented accordingly.

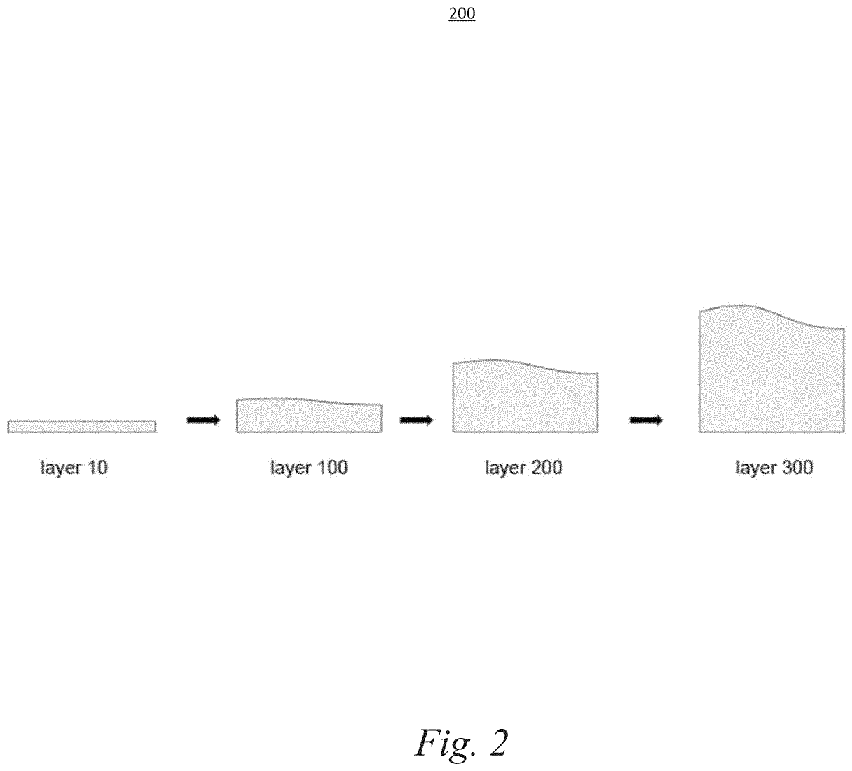

FIG. 2 shows an overview of a 3D printing process 200 in which an error accumulates. FIG. 2 depicts a 3D printed at various stages of printing: a first stage in which 10 layers have been deposited, a second stage in which 100 layers have been deposited, a third stage in which 200 layers have been deposited, and a fourth stage in which 300 layers have been deposited. In the depicted example, a top surface of the 3D printed object should be even, according to specifications for the 3D printed object (in other embodiments, the top surface need not be even, and may have any appropriate shape). However, as shown in FIG. 2, the 3D printer implementing the depicted process deposits too much ink on the left side of the 3D printed object, and/or not enough ink on the right side of the 3D printed object. This may be due to factors such as defects in the 3D printer related to manufacture of the 3D printer, clogging of ink nozzles or other ink depositing structures, or other factors. This systemic error repeats with each pass of a 3D printer head that deposits the ink, and the unevenness of the top surface of the 3D printed object grows during the 3D printing process.

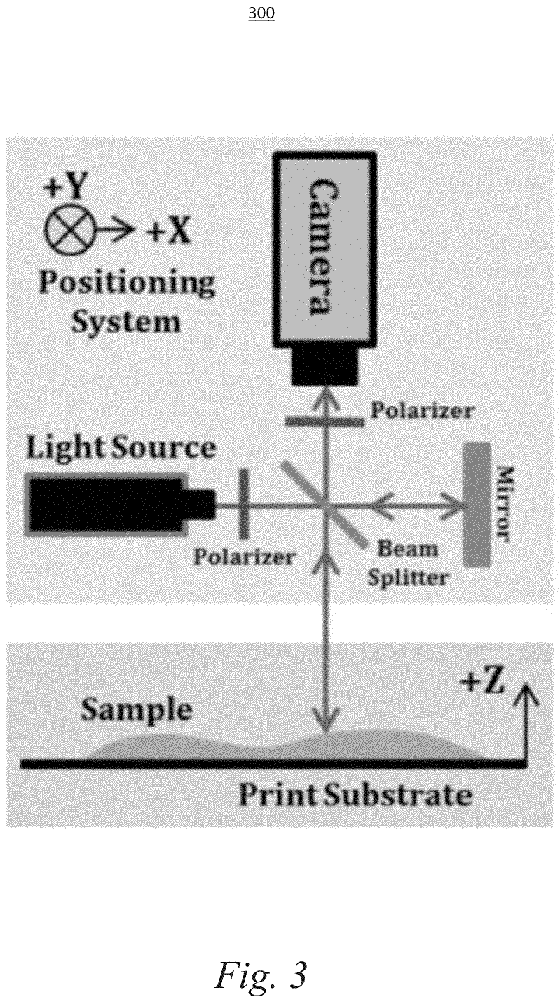

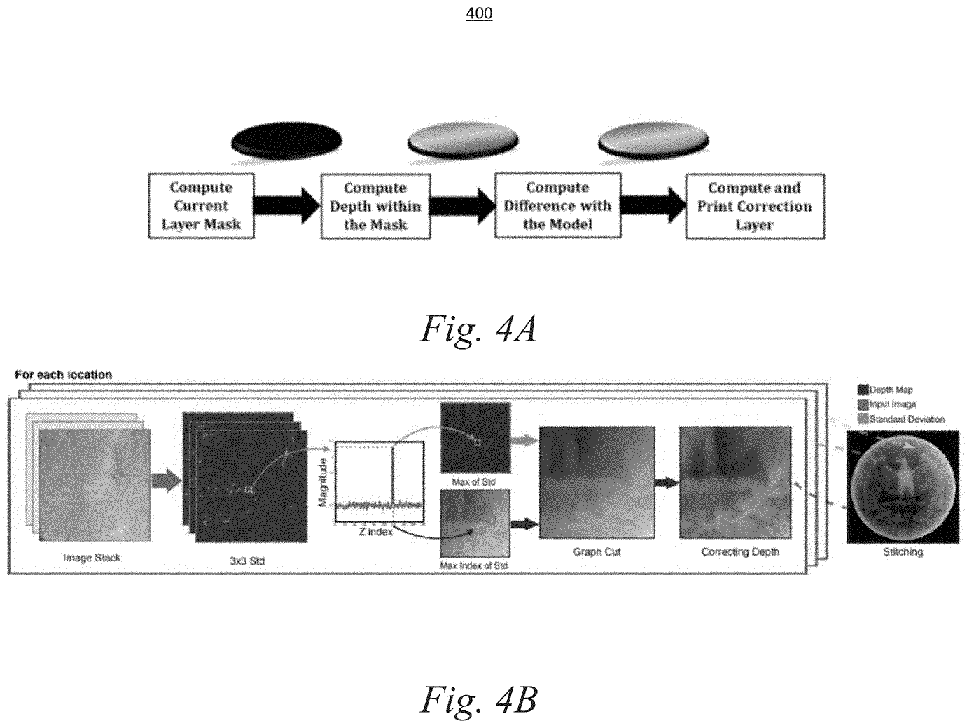

FIGS. 3, 4A and 4B show a comparative technique for addressing 3D printing errors involving using optical coherence tomography to determine a correction layer for a 3D printed object. FIG. 3 shows a system for measuring a surface of a 3D printed object using optical coherence tomography. The depicted system involves a light source, a beam splitter, a mirror, multiple polarizers, and a camera, all disposed at specified positions. The depicted system can measure a height of the “sample” or 3D printed object, and a positioning system can implement precise movements of components of the system to image the height of different portions of the 3D printed object. This technique involves precise control of moving parts, and can be expensive and inconvenient to implement.

FIGS. 4A and 4B show a method of analysis implemented using optical coherence tomography. FIG. 4A shows an overview of a method that can involve computing a current mask layer (e.g., a simulation of a top layer of an imaged 3D printed object), computing a depth within the mask (e.g., determining a height of the top surface), computing a height difference relative to a reference model, and computing and printing a correction layer accordingly. FIG. 4B shows some of the complex and computer resource-intensive algorithms used to implement the method shown in FIG. 4A. As shown in FIG. 4B, for each imaged location, an image stack is determined, a 3 pixel by 3 pixel sized filter or matrix window is used to analyze or process each image, and an estimated a Z index (relating to a depth or height) is computed for each position in the images, a maximum of the Z index and a corresponding index of the maximum is determined for the position, a graph cut is determined based on the maximum and the corresponding index, and finally a correcting depth is determined for the correction layer. Compared to systems and methods disclosed herein, this process can involve complex algorithms that involve significant computing resources and time to implement, and the depicted process may not be suitable for certain applications, such as quality control in factory automation lines.

For example, the Z index may be computed based on a known known distance D between an emitter device and a receiver device, which can be maintained in computer memory of the system. Computing the Z index (e.g., a value indicative of a height or mapping of objects in the images, etc.) can include performing one or more image analysis techniques such as filters, masks, or other transformations. For example, to determine sharp includes or other features in an image, the system may perform a Fourier transform (fast-Fourier transform, etc.) on the image to compute edges of objects that may be present in the image. In some implementations, computing the Z index can include computing a 3×3 variance value or a 3×3 standard deviation value of the pixels. For example, the system can use a 3×3 sliding window of pixels, and compute a standard deviation or variance value using the 3×3 sliding window of pixels. The system can move the sliding window over some or all of the pixels of the image, such that each pixel is represented by a numerical value in a 3×3 matrix. In some implementations, the system can perform this analysis on a small portion of each image, and repeat the process serially or in parallel to compute corrected depth information for each location in the image.

Prior to computing the standard deviation, the system may compute a depth map of the one or more pixels (e.g., compute an estimated height value for each of the pixels relative to a baseline value, etc.). In some implementations, the system can perform the standard deviation computations using the depth map or height map computed from the images. Using the Z index, the system can perform additional smoothing filters to generate an image with a corrected depth. For example, using the maximum standard deviation and the maximum index of the standard deviation as reference values, the system can identify and compute corrected depth information. To compute the corrected depth, various graph cutting algorithms may be implemented to smooth or sharpen the depth image based on the standard deviation or Z index of the portion of each image undergoing analysis. After a corrected depth image for each portion of the image under analysis has been computed, the system can stitch each of the corrected depth image portions into a single corrected depth image.

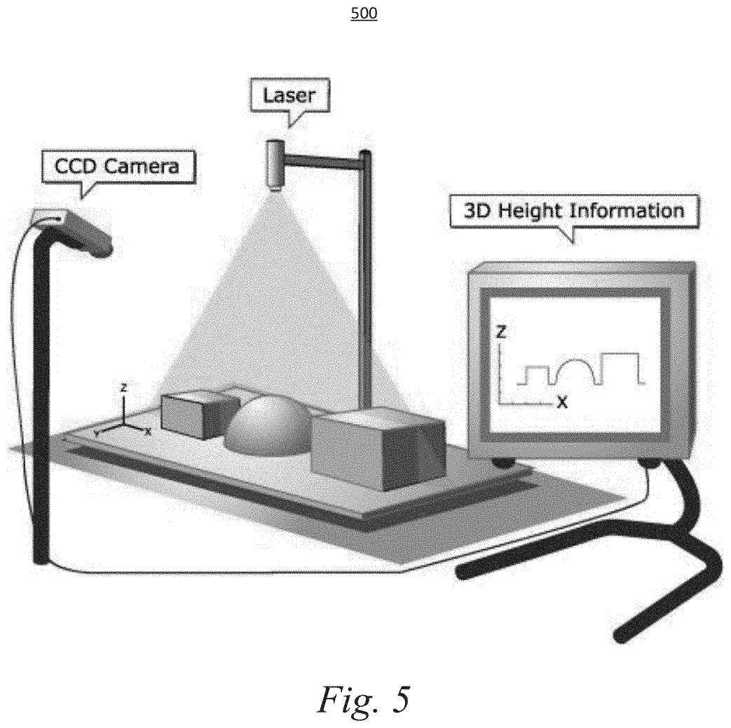

FIG. 5 depicts an overview of an embodiment of the present disclosure. As shown in FIG. 5, a laser emitter may be implemented to illuminate or scan a 3D printed object (in the depicted example, the 3D printed object includes two differently shaped cubes and a hemisphere). The laser can be, for example, a laser line scanner that emits a plurality of laser light points (e.g., hundreds of laser light points) directed in a specified direction. In some embodiments, laser includes a lens, and may emit a point (e.g. a single point) that is expanded by the lens (e.g. expanded along one dimension to produce a line). A receiver (e.g., a receiver implemented in a camera, such as a charge-coupled device (CCD) camera) can be disposed a known (or inferred) distance from the laser emitter, and may record laser light reflecting off the surface of the 3D printed object. Based on the known distance (e.g. using triangulation techniques), a height of the scanned surface can be determined.

The laser (e.g., the emitter device) can emit light form a plurality of points, or, in some implementations, from single point that is refracted, reflected, or bent using a lens to expand the laser point along a single dimension or axis. For example, the laser may include a programmable or non-programmable lens that can receive light from single point in the laser, and bend or project the light such that along a single dimension such that it resembles the beam portrayed in FIG. 5. Each of the laser emitter and the camera may be disposed at a fixed distance from each other, and may each be communicatively coupled with a 3D printing device. The 3D printing device may be configured to detect the top of laser light as it appears in an image captured by the receiver CCD camera, and compute one or more pixel locations in the image that correspond to the top of a 3D printed object. From these pixel locations, the system can generate height information that describes the height and characteristics of the object undergoing 3D printing, which may be used by the 3D printing device to compute a correction layer, if needed.

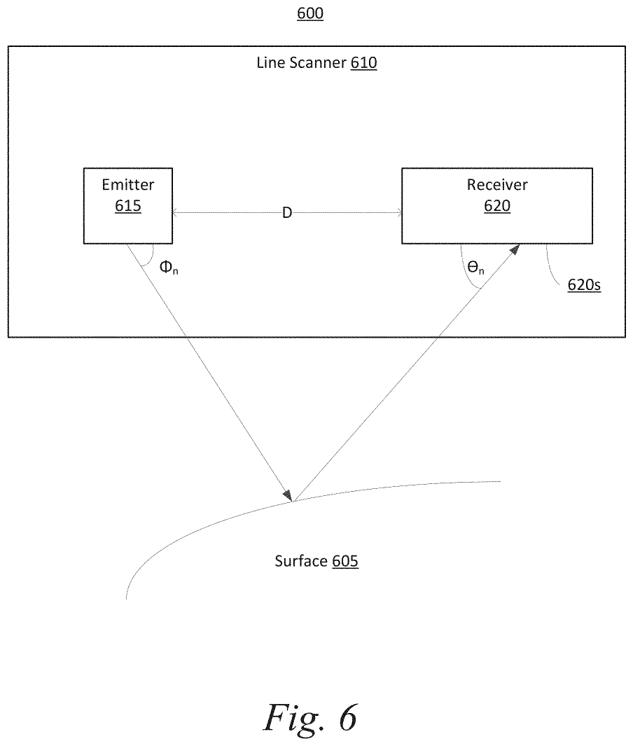

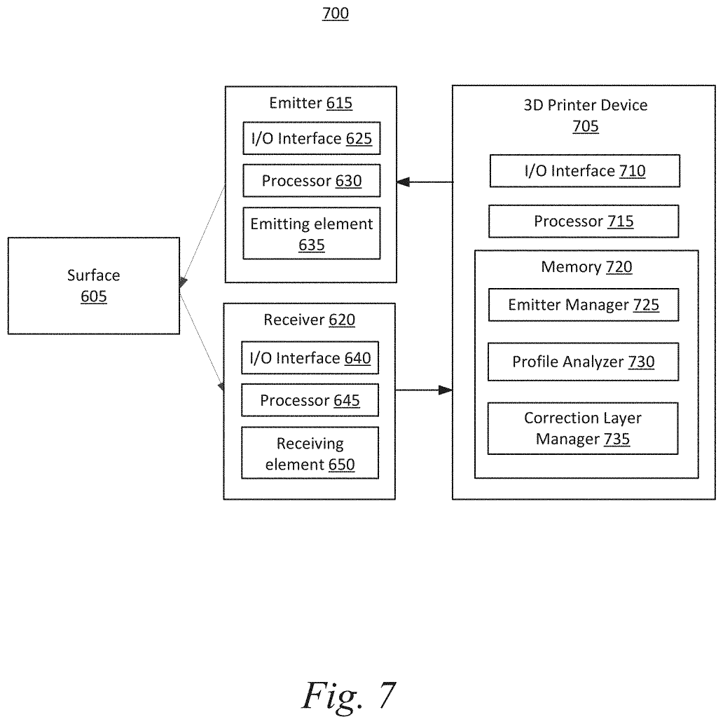

FIG. 6 shows an example embodiment of a 3D printing system 600 including a line scanner 610 that includes a laser emitter 615 and a receiver 620, and that is used to scan a surface 605 of a 3D printed object. Although the emitter 615 and the receiver 620 are depicted as being bodily integrated into a same device (which may be useful, for example, in factory automation line implementations), in some embodiments those components are separated (e.g. as shown in FIG. 4) and may be moved separately.

As shown in FIG. 6, the emitter 615 and the receiver 620 can be disposed a known distance D apart from each other. Although the emitter 615 and the receiver 620 are shown as being disposed at a same height, in other embodiments those components may be disposed at different heights. The emitter 615 emits laser light (e.g., a line of laser light) at a specified angle Φₙ (e.g., relative to an emitting surface of the emitter 615) towards the surface 605. The laser light reflects off the surface 605 and is received by the receiver 620 at an angle θₙ. The light may be received by a receiving surface 620s of the receiver 620. Using the known distance D (which may be a distance between a specific receiving or lens element of the receiver 620 that receives the laser light, and a specific emitting or lens element of the emitted 615 that emits the laser light) and the known angles Φₙ and θₙ, a height difference between the emitter 615 or the receiver 620 and the scanned area of the surface 605 can be determined, using, for example, triangulation techniques including the law of cosines and the law of sines. Using a known vertical position for the emitter 615 or the receiver 620 relative to a base of the 3D printer object (e.g., a base layer or a platform or substrate on which the 3D object is printed), a height of the surface 605 can be determined.

The emitter 615 may be configured to accept, receive, or execute instructions receive from a computing device. In some implementations, the emitter 615 may include one or more processors and a memory, or may include one or more general purpose or specialized computing devices as described herein. In some implementations, the emitter can be configured to emit light at more than one angle, or may emit light in a sequence of angles based on the instructions. For example, the instructions may include information that, when executed by the processors or computing device of the emitter 615, cause the emitter 615 to emit light on the surface 605 at the angle specified in the instructions (e.g., or an angle that approximates that angles within a threshold, such as within +/−1%, +/−2%, +/−5%.+/−10%, or any range therein, etc.). The instructions may include a time value that corresponds to a duration at which the emitter 615 should emit light on the surface at the specified angle. Once the system determines that the emitter 615 has emitted light at the specified angle for the time period specified in the instructions (or a predetermined time period, such as one stored in a settings file or configuration file, etc.), the emitter may further execute instructions to emit light at a second angle on the surface 605. This process may continue in sequence until the emitter 615 has emitted light at all emission angles specified in the instructions. At this point, the emitter 615 may terminate the execution of the instructions, or may continue to execute other instructions provided to the emitter 615.

In some embodiments, the receiver 620 is a camera, such as a CCD camera. Each of the receiving elements of the receiver 620 may correspond to one or more pixels of an image produced by the receiver 620. Thus, the pixels of the image produced by the receiver 620 may be respectively associated with angles θₙ, and detection of laser light in a particular pixel may mean that the laser light was incident on the receiver 620 at a particular angle θₙ. The camera may be configured to receive light at more than one angle, or may be configured to determine or calculate the angle of incidence of the light emitted from the emitter 615 based on the light that is reflected from the surface 605. The receiver 620 may capture one or more images or other light information, and transmit this information to a 3D printing device for further analysis. In some implementations, the receiver 620 can transmit the angle of incidence to the 3D printing device, along with the light information or images.

FIG. 7 shows a 3D printing system 700 according to some embodiments of the present disclosure. The 3D printing system 700 includes an emitter 615, a receiver 620, and a 3D printer device 705, and is configured to scan a surface 605 of a 3D printer object and to determine a correction layer to apply to the 3D printed object. Specifications for the determined correction layer may be sent by the 3D printer device 705 to a 3D printer (not shown), which may be part of the 3D printer device, or may be a separated device connected to the 3D printer device 705 (e.g., over a network connection or by a wired connection). In some implementations, each of the emitter 615, the receiver 620, and the 3D printer device can be part of the 3D printer.

The emitter 615 may be a laser emitter configured to emit laser light. The emitter 615 may include an input/output (I/O) interface 625, a processor 630, and an emitting element 635. The emitter 615 can include at least one processor 630 and a memory, e.g., a processing circuit. The memory can store processor-executable instructions that, when executed by processor 630, cause the processor 630 to perform one or more of the operations described herein. The processor 630 may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The instructions may be received, for example, from the 3D printer device 705.

The emitting element 635 can include, for example, a line laser configured to emit a laser line that includes a plurality of laser points (e.g. a number of laser points in a range of 1-10, in a range of 10-100, or in a range of 100-200, or more than 200). In some embodiments, the emitter 615 includes a lens, and the emitter 615 may emit a point (e.g. a single point) that is expanded by the lens (e.g. expanded along one dimension to produce a line). The emitting element 635 may emit light of an appropriate frequency (e.g., light for which the receiver 620 is configured to receive and process, or light of a wavelength that does not adversely affect or damage the 3D object being printed (e.g., light having a low energy, such light as having a wavelength higher than the visible spectrum). The frequency of the light emitted by the emitting element can, in some implementations, be provided as part of the instructions received from the 3D printing device 705. The emitting element 635 may be configured to emit light (e.g., lines of laser light) at a plurality of angles Φ₁ through Φₙ, according to instructions or signals received from the processor 630. The instructions may specify other characteristics of the light emitted by the emitter device 635, such as the shape of the emitted light, the frequency of the emitted light, the wavelength of the emitted light, emission patterns (e.g., duration of emission/non-emission of light, etc.), and other characteristics.

The I/O interface 625 may be configured to receive instructions from the 3D printer device 705 (e.g. over a network, or via a wired connection), including instructions to begin emitting light or instructions to emit light at one or more of the plurality of angles Φ₁ through Φₙ. The instructions may specify emitting light at the angles Φ₁ through Φₙ in a specified order. The processor 630 may include a microprocessor, an application-specific integrated circuit (ASIC), a field-programmable gate array (FPGA), etc., or combinations thereof. The processor 630 may be configured to process the instructions, and to execute the instructions by causing the emitting element 635 to emit laser light at one or more angles specified by the instructions.

In some embodiments, the emitter 615 may be attached to a carriage of a 3D printer that includes printheads. Thus, an imaging system can be added to the 3D printer and can scan a surface of the 3D printed object without needing to add additional moving parts. This may also enable the system to scan while the printer is printing. In such implementations, the distance from the emitter 615 may be tracked by the 3D printer and may be transmitted or provided to the other components of the system 700, as needed. For example, the 3D printer device 705 may utilize the distance (e.g., the distance D as described above), between the emitter 615 and the receiver 620 to determine the depth or height map of an object undergoing a 3D printing process.

The receiver 620 may include an I/O interface 640, a processor 645, and a receiving element 650. The receiver 620 may implement a lens, such as a macro lens, that enables the receiver 620 to implement a close focal point and can provide for improved accuracy. In some implementations, the lens of the receiver may be removable or otherwise replaceable, such that different lenses with different parameters or outcomes may be used for certain materials or designs. The receiver 620 may include one or more optical filters that can reduce or otherwise block wavelengths or frequencies of undesired light from reaching the receiver 620. Such filters may be replaceable, such that different filters may be used in different configurations to suit the light emitted from the emitter 615.

The receiving element 650 may be configured to receive laser light emitted by the emitter 615 and reflected by the surface 605. The receiving element 650 may be disposed a known distance D from the emitting element 635. The receiving element 650 may be configured to detect an angle of incidence θₙ of the received laser light. Detecting the angle of incidence can include performing one or more image analysis techniques, such as edge detection or Fourier transform. Those or other image analysis techniques may be used in conjunction with the known distance between the emitter 615 and the receiver 620 to compute the angle of incidence. The receiving element 650 may be configured to operate in a range of wavelengths corresponding to wavelengths of light emitted by the emitting element 635. The receiving element 650 may be configured to generate an analog signal responsive to receiving light, and the analog signal (or a digital signal generated based on the analog signal) can be sent to the processor 645.

The receiver 620 can include at least one processor 645 and a memory, e.g., a processing circuit. The memory can store processor-executable instructions that, when executed by processor 645, cause the processor 645 to perform one or more of the operations described herein. The processor 645 may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor 645 can read instructions. The instructions may include code from any suitable computer programming language, and may be received from the 3D printer device 705.

The processor 645 (e.g., or the instructions configured to execute thereon, etc.) may be configured to determine, based on the analog signal generated by the receiving element 650, the angle of incidence θₙ. This can be determined, for example, based on where in the receiving element 650's point of view the light is received/seen. For example, the receiving element 650 may have a receiving surface 620s that extends horizontally as shown in FIG. 6, and the receiving element 650 may generate an analog signal that indicates where on the receiving surface the light was received. For example, the receiving surface may comprise a plurality of photovoltaic elements disposed along the receiving surface 620s at specified positions, and the analog signal being generated by a particular photovoltaic element may indicate that the light was received at a particular position on the receiving surface 620s. The processor 645 may be configured to determine the angle of incidence θₙ based on where on the receiving surface 620s the light was received (e.g. based on receiving an analogue signal, or a signal derived therefrom, from a particular photovoltaic element having a known position). In some implementations, the processor 645 can transmit the analog signal, images, or any other information captured by the receiver 620 to the 3D printer device 705 for further processing or analysis.

The I/O interface 640 may be configured to provide information regarding the received light to the 3D printer device 705 (e.g. over a network, or via a wired connection), including information indicating any of a magnitude or strength of received light, an angle of incidence of the received light, and a time of the received light. The processor 645 may transmit information including the angle of incidence θₙ to the 3D printer device 705 via the I/O interface 640.

The receiver 620 may be configured to receive a plurality of incident lights at respective angles of incidence θ₁ through θₙ. The processor 645 may transmit the received light in the order the lights are received, or in a manner indicating the order in which they were received, with may permit the 3D printer device 705 to correlate the angle of incidence with the angles Φ₁ through Φₙ that the emitter 615 was instructed to emit. As such, in some implementations, the receiver 620 can receive instructions or indications from the 3D printer device 705 to capture images in a particular order. For example, the instructions may indicate that the emitter 615 will emit light at various angles of incidence according to a schedule or series of time periods. The processor 645 of the receiver 620 can execute the instructions such that the appropriate data is captured for each angle of incidence emitted by the emitter 615, and that each image, analog signal, or other light information that corresponds to that angle of incidence or emission event is transmitted to the 3D printer device 705 with an indication of that event. Such an indication may include an index value (e.g., the first light emitted from the emitter 615, the second light emitted from the emitter 615, and so on, etc.), or other value that indicates the specified order of the captured data.

In some embodiments, the receiver 620 includes a camera, such as a CCD camera, configured to produce an image. Each of the receiving elements of the receiver 620 may correspond to one or more pixels of the image produced by the receiver 620. Thus, the pixels of the image produced by the receiver 620 may be respectively associated with angles θₙ, and detection of laser light in a particular pixel may mean that the laser light was incident on the receiver 620 at a particular angle θₙ. The I/O interface 620 of the receiver 620 may be configured to transmit the image (or image data corresponding to the image) to the 3D printer device 705. Images may be captured in a variety of formats, such as RAW image format or a compressed image format (e.g., JPEG, etc.). The image may include metadata that indicates features or characteristics of the image, which may be used by the 3D printer device 705 to perform one or more calculations of the angle of incidence, the height map, the profile, or the depth map, as described herein.

The 3D printer device 705 may include an I/O interface 710, a processor 715, and a memory 720 storing processor-executable instructions. The processor-executable instructions may include programs, applications application programming interfaces, libraries, or other computer software for performing processes described herein. The memory 720 may include, but is not limited to, electronic, optical, magnetic, or any other storage or transmission device capable of providing processor with program instructions. The memory 720 may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®. For example, the memory 720 may include an emitter manager 725, a profile analyzer 730, and a correction layer manager 735.

The I/O interface 710 may be configured to communicate with the I/O interface 625 and the I/O interface 640. For example, the I/O interface 710 may be configured to send instructions to the emitter 615 to emit light at angles Φ₁ through Φₙ, as described above. The I/O interface 710 may be configured to receive information from the receiver 620 regarding received light and corresponding angles of incidence θ₁ through θₙ. Receiving such information may be responsive to the transmission of instructions to the receiver 620 to capture image data, analog signals, or light information. This information may include metadata, such as an order or sequence of the data that each correspond to an angle of incidence.

The processor 715 may include a microprocessor, an application-specific integrated circuit (ASIC), a field-programmable gate array (FPGA), etc., or combinations thereof. The processor 715 may be configured to execute any of the processor-executable instructions stored in the memory 720, including any of the emitter manager 725, a profile analyzer 730, and a correction layer manager 735.

The emitter manager 725 may include one or more applications, services, routines, programs, or other executable logics for managing the emitter 615. For example, the emitter manager 725 can generate instructions to send to the emitter 615 via the I/O interface 710. As discussed above, the instructions may instruct the emitter 615 to emit light (e.g., lines of laser light) at a plurality of angles Φ₁ through Φₙ. The instructions may cause the emitter 615 to emit the light at the plurality of angles Φ₁ through Φₙ in a particular order.

The profile analyzer 730 may determine a profile for the surface 605 based on information received from the receiver 620. The profile may indicate a height or depth of the 3D printed object being analyzed (e.g. relative to a base or substrate on which the 3D printed object is printed). The height of a particular portion of the surface 605 may be determined based on the known distance D between the emitter 615 and the receiver 620 (which value can be stored in the memory 720), the angle Φₙ at which light that illuminated the particular portion of the surface 605 was emitted, and the angle of incidence θₙ at which the corresponding light was received by the receiver 620. For example, the profile analyzer may receive information sent by the receiver 620 that includes an ordered set of angles of incidence θ₁ through θₙ. The profile analyzer 730 may match the ordered set of angles of incidence with the set of emission angles Φ₁ through Φₙ included in the instructions generated by the emitter manager 725 to determine a set of emission angle-angle of incidence pairs. For each such pair, the profile analyzer 730 may use the known distance D and triangulation techniques to determine a vector between the illuminated point on the surface 605 and the emitter 615 and/or a vector between the illuminated point on the surface 605 and the receiver. Thus, the position of a plurality of illuminated points of the surface 605 can be determined to generate a profile of the surface 605.

In some embodiments, the profile analyzer 730 may analyze an image received from the receiver 620. The image may include a plurality of pixels, and the profile analyzer 730 may detect laser light in or more of the pixels. The pixels may respectively correspond to angles of incidence θₙ, and the profile analyzer 730 may determine an angle of incidence of the detected laser light based on which pixel(s) the laser light was detected in. For example, the profile analyzer 730 may refer to a look-up table (LUT) that associates pixels and angles of incidence to determine an angle of incidence of the laser light.

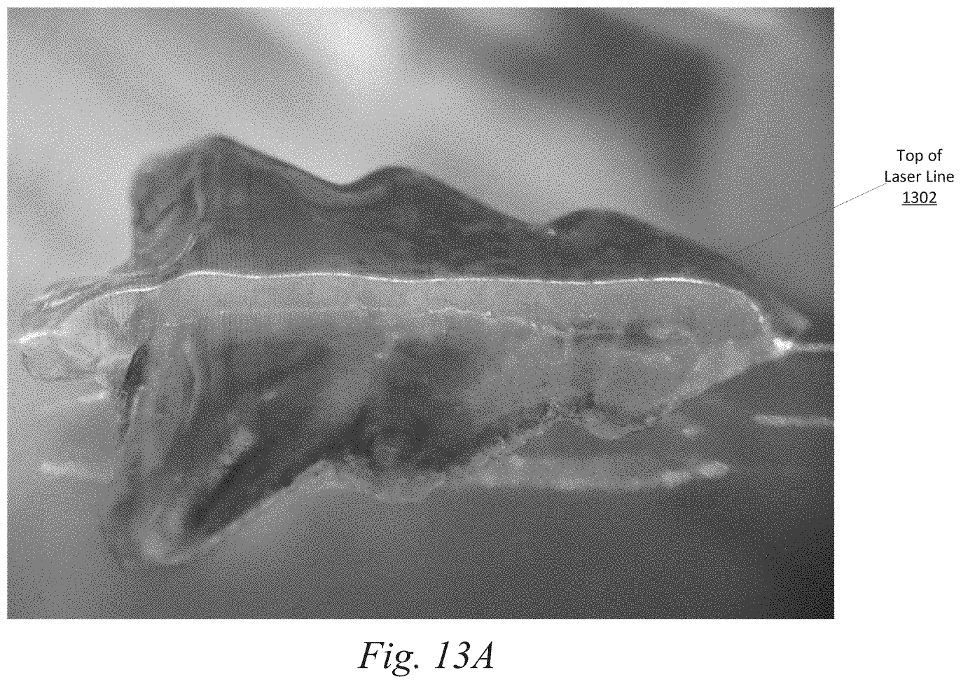

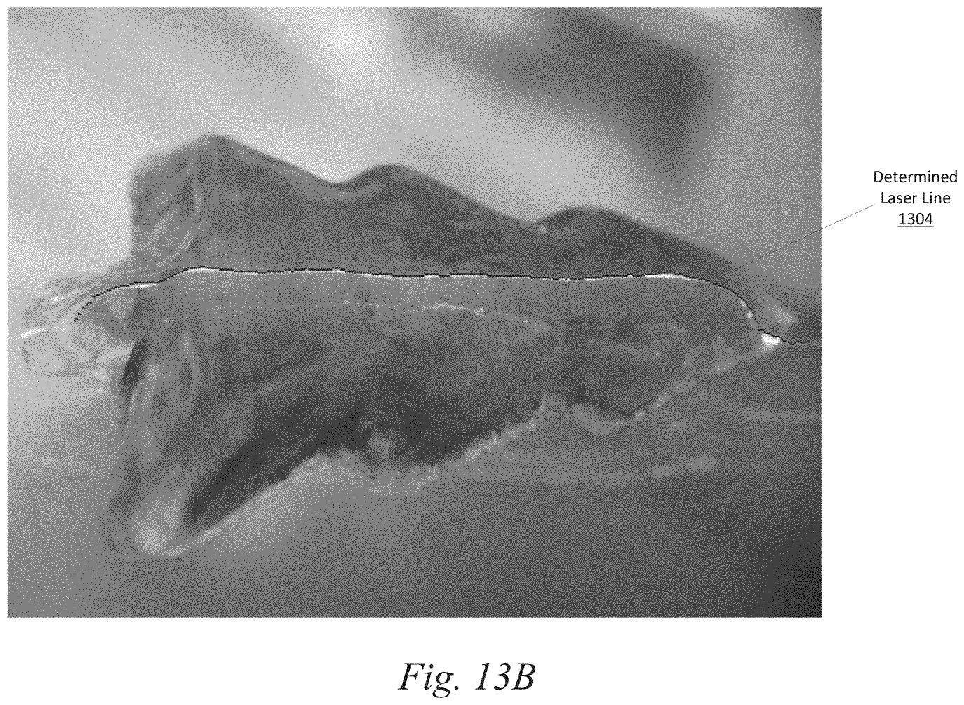

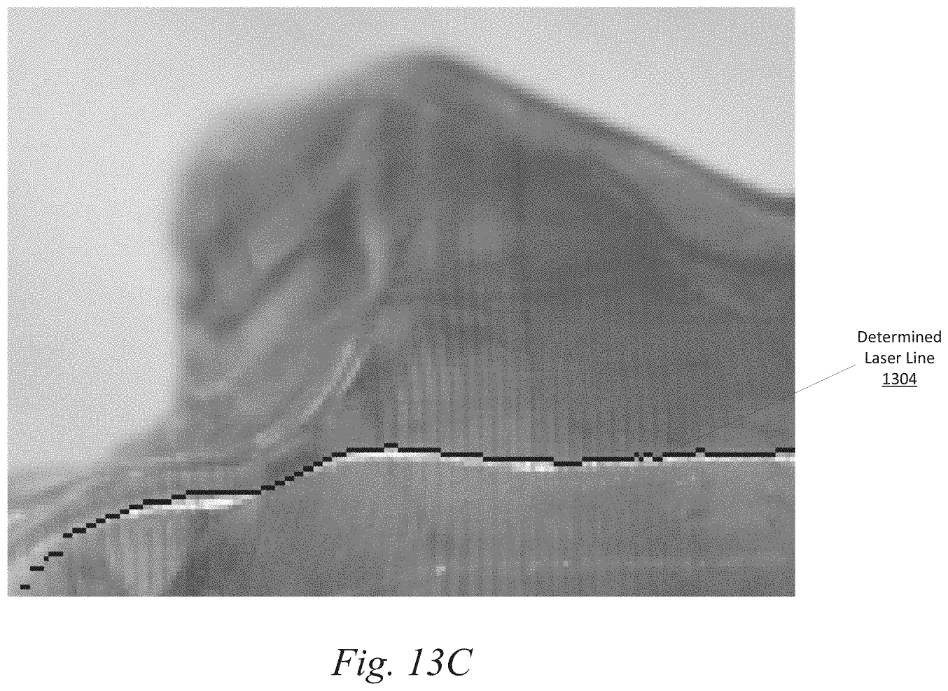

In some embodiments, the profile analyzer 730 may analyze the image received from the receiver 620 to determine a “top” or “peak” of a laser. In some implementations, scanning certain 3d printing inks (e.g., at least somewhat translucent inks) with a laser is difficult due to an internal spreading of the laser beam. As shown in FIG. 13A, which depicts a translucent 3D printed object on a printbed illuminated by a line laser, the laser line may have a “top” (e.g., a highest intensity) 1302 along a line where the laser strikes the 3D printed object, and at least some of the laser is dispersed within the 3D printed object. It can be challenging to identify the top of the laser line 1302 (which is disposed along a top of the 3D printed object and can be used to determine a height of the 3D printed object) and to avoid misidentifying dispersed laser within the 3D printed object as the top of the laser line, and a number of conventional laser scanning techniques involve detecting the middle of the detected laser light, not the top.

In some embodiments, the profile analyzer 730 may analyze the image received from the receiver 620 to detect the top of the laser line 1302 by analyzing vertical pixel columns of the image. For example, one or more columns of pixels are analyzed to determine one or more pixels having a feature related to the top of the laser line 1302. The feature may include a highest brightness value. The feature may be related to a color, a hue, a saturation, a lightness value, or some other pixel characteristic associated with the laser. In some embodiments, the profile analyzer 730 may determine a change in a one of the above features scanning from one end of the column of pixels to an opposite end of the column of pixels, and a change at a certain rate may correspond to a location of the laser (e.g., a zero (or smallest) rate of change may indicate a peak of a value, which may indicate that the top of the laser is located at pixels exhibiting the zero rate of change). In some embodiments, sub-pixel interpolation may be employed in any of the above analysis.

The profile analyzer 730 may thus determine, for each column of a plurality of columns of pixels, a location of the laser line 1302. FIG. 13B shows an example of such a determined laser line, in which the profile analyzer 730 determined the laser line 1304. FIG. 13C shows a zoomed-in image of the image shown in FIG. 13B. The profile analyzer 730 may use the pixels of the determined laser line 1304 to determine angles of incidence θₙ of the laser relative to the receiver 620, using any of the techniques described herein.

The correction layer manager 735 can determine a correction layer based on the profile of the surface 605 determined by the profile analyzer 730 and based on specifications for the 3D object being printed. For example, the correction layer manager 735 can determine a difference profile indicating a difference at a plurality of points between the profile of the surface 605 and a specified height or depth indicated by the specifications. The correction layer manager 735 can determine a correction layer that compensates, at least in part, for the determined difference. For example, the correction layer manager 735 may determine that a height of one or more portions of the surface 605 is lower than it should be (according to the specifications), and the correction layer manager 735 may determine a correction layer that has a thickness corresponding to (e.g. substantially equal to) the determined difference. In some embodiments, the correction layer manager 735 may determine that a height of one or more portions of the surface 605 is higher than it should be (according to the specifications), and the correction layer manager 735 may determine a correction layer that raises other portions of the surface 605 to mitigate a height difference between the overly-high portions and the other portions of the surface 605. The correction layer manager 735 may generate instructions for a 3D printer to implement or apply the correction layer. As discussed above, the 3D printer may be part of the 3D printer device, or may be a separate device, in which case the 3D printer device 705 may transmit instructions to the 3D printer (e.g., via the I/O interface 710) to generate the correction layer.

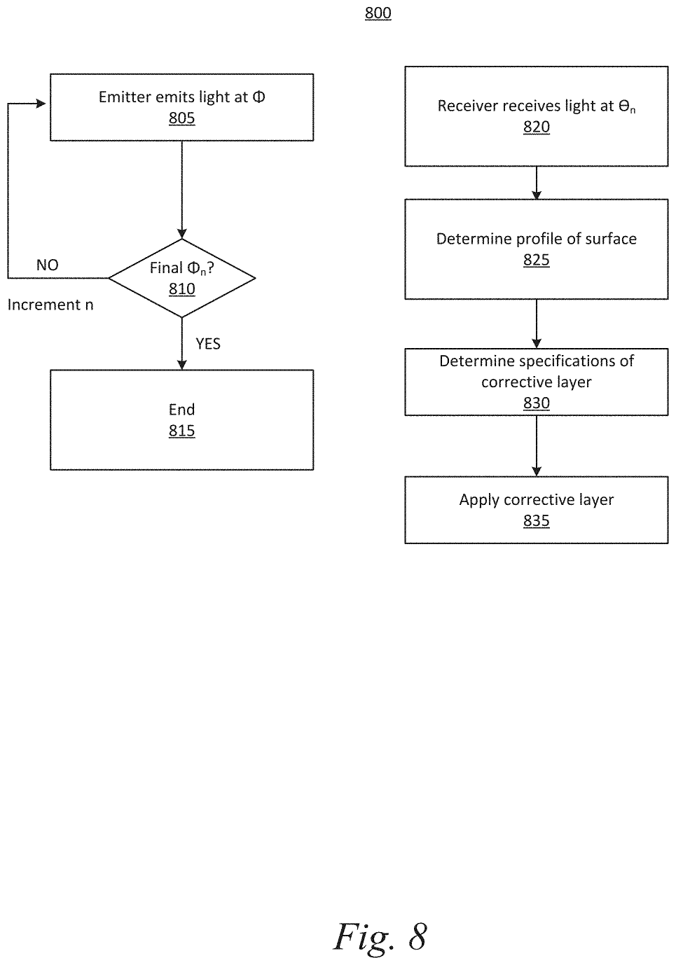

Referring now to FIG. 8, FIG. 8 shows an example embodiment of a method 800 for determining a correction layer. The method 800 can include emitting light an angle of incidence Φ 805, determining whether the angle Φ is the final angle of the ordered sequence 810, ending the emission of light on the surface 815, receiving light at a detected angle of incidence θₙ 820, determining a profile of the surface illuminated by the emitter 825, determining specifications of a corrective layer 830, and applying (or generating instructions to apply, etc.) a corrective layer to the surface 835. The method 800 can be carried out, for example, by the 3D printer device 706 of the system 700, or any combination of the devices included in the system 700 described herein above in reference to FIG. 7.

In process 805, the emitter 615 emits light at an angle Φ towards a surface 605 of a 3D printed object. The emitter 615 may be instructed by the emitter manager 725 to emit light at a plurality of angles Φ₁ through Φₙ (e.g., in an ordered sequence). The processor 630 of the emitter 615 may refer to an index n of emission angles, and may cause the emitting element 635 to emit light at an angle T. The sequence of light at the n specified emission angles may be specified or indicated in instructions provided, for example, by the 3D printer device 705 to the emitter 615.

In process 810, the processor determines whether the angle Φ is the final angle of the ordered sequence of angles included in the instructions received from the 3D printer device 705. If θ is the final angle to be implemented, the operation of the emitted 615 ends in process 815 (and, in some embodiments, transmits an indication to the 3D printer device 705 that the instructions have been executed). If the θ is not the final angle, the emitter 615 increments the index of the emission angles, and the emitter returns to operation 805 to emit light at the next instructed angle θ.

In process 820, the receiver 620 receives light at a detected angle of incidence θₙ. The receiver 620 may receive a plurality of lights at a plurality of detected angles of incidence θ₁ through θₙ. The receiver 620 may transmit information to the 3D printer device 705, including any of a magnitude or strength of the received light, the angles of incidence θ of the received light, and an order in which the light was received. Detecting the angle of incidence can include performing one or more image analysis techniques, such as edge detection or Fourier transform. Those or other image analysis techniques may be used in conjunction with the known distance between the emitter 615 and the receiver 620 to compute the angle of incidence. The receiving element 650 may be configured to operate in a range of wavelengths corresponding to wavelengths of light emitted by the emitting element 635. The receiver 620 may be configured to generate an analog signal responsive to receiving light, and the analog signal (or a digital signal generated based on the analog signal) may be transmitted, for example, to the 3D printer device 705.

In process 825, the profile analyzer 730 may determine (or generating, etc.) a profile of the surface 605. The profile analyzer 730 may determine a profile for the surface 605 based on information received from the receiver 620. The profile may indicate a height or depth of the 3D printed object being analyzed (e.g. relative to a base or substrate on which the 3D printed object is printed). The height of a particular portion of the surface 605 may be determined based on the known distance D between the emitter 615 and the receiver 620 (which value can be stored in the memory 720), the angle Φₙ at which light that illuminated the particular portion of the surface 605 was emitted, and the angle of incidence θₙ at which the corresponding light was received by the receiver 620. For example, the profile analyzer may receive information sent by the receiver 620 that includes an ordered set of angles of incidence θ₁ through θₙ. The profile analyzer 730 may match the ordered set of angles of incidence with the set of emission angles Φ₁ through Φₙ included in the instructions generated by the emitter manager 725 to determine a set of emission angle-angle of incidence pairs. For each such pair, the profile analyzer 730 may use the known distance D and triangulation techniques to determine a vector between the illuminated point on the surface 605 and the emitter 615 and/or a vector between the illuminated point on the surface 605 and the receiver. Thus, the position of a plurality of illuminated points of the surface 605 can be determined to generate a profile of the surface 605.

In process 830, the correction layer manager 735 may determine specifications for a correction layer based on differences between the detected profile of the surface 605 and specifications of the 3D printed object. The correction layer manager 735 can determine a correction layer based on the profile of the surface 605 determined by the profile analyzer 730 and based on specifications for the 3D object being printed. For example, the correction layer manager 735 can determine a difference profile indicating a difference at a plurality of points between the profile of the surface 605 and a specified height or depth indicated by the specifications. The correction layer manager 735 can determine a correction layer that compensates, at least in part, for the determined difference. For example, the correction layer manager 735 may determine that a height of one or more portions of the surface 605 is lower than it should be (according to the specifications), and the correction layer manager 735 may determine a correction layer that has a thickness corresponding to (e.g. substantially equal to) the determined difference. In some embodiments, the correction layer manager 735 may determine that a height of one or more portions of the surface 605 is higher than it should be (according to the specifications), and the correction layer manager 735 may determine a correction layer that raises other portions of the surface 605 to mitigate a height difference between the overly-high portions and the other portions of the surface 605.

In process 830, the correction layer may be applied. The correction layer manager 735 may generate instructions for a 3D printer to implement or apply the correction layer. As discussed above, the 3D printer may be part of the 3D printer device, or may be a separate device, in which case the 3D printer device 705 may transmit instructions to the 3D printer (e.g., via the I/O interface 710) to generate the correction layer. Such instructions may be inserted between or among existing instructions to print or manufacture a 3D object. The instructions may override an existing 3D printing process, such that a new layer is inserted in the process. The instructions specifying layers subsequent to the correction layer may be modified to compensate for the material added by the correction layer.

Thus, the method 800 may provide for determine and applying a correction layer for accurate 3D printing. The method 800 may be more accurate and faster than comparative techniques described herein, and may involve using less computing resources. The method 800 can be carried out by any of the processing or computing devices described herein.

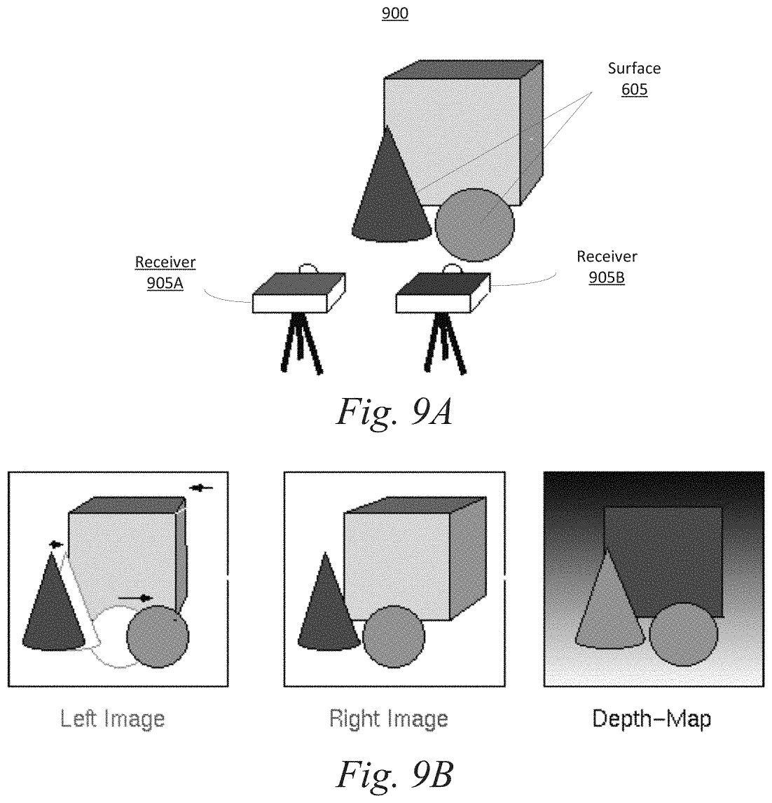

Referring now to FIG. 9A, an overview of a parallax technique is shown in which a depth or height of a surface 605 of a 3D printed object is determined using a plurality of receivers (e.g., a receiver 905A and a receiver 905B). In other embodiments, a single receiver may be used, and may be moved from a first position to a second position. By thus imaging the surface 605 from different positions, a depth or height of the surface 605 can be determined. The systems and methods described herein may automatically calculate or determine the depth map by interpolating information between two images. Each of the receiver 905A and the receiver 905B can operate as the receiving devices (e.g., the receiver 620, CCD cameras, and all others, etc.) as described herein.

FIG. 9B shows a first image (referred to as a left image in the depicted example) and a second image (referred to as a right image in the depicted example). These images are images of the surface 605 of the 3D object being printed taken from different positions. As shown, the surface 605 in the left image appears to be shifted relative to a background (e.g., a backdrop) of the 3D object being printed. The detected shift, or positional differences between the first image and the second image, can be used to generate a depth map of the surface 605 by implementing parallax techniques. The depth map may serve as a profile of the surface 605, and using system and processes described herein (e.g., the correction layer manager 735 described above with respect to FIG. 7, or processes 830 and 835 described above with respect to FIG. 8), a correction layer can be determined based on the profile and can be applied to improve the accuracy of the 3D printed object.

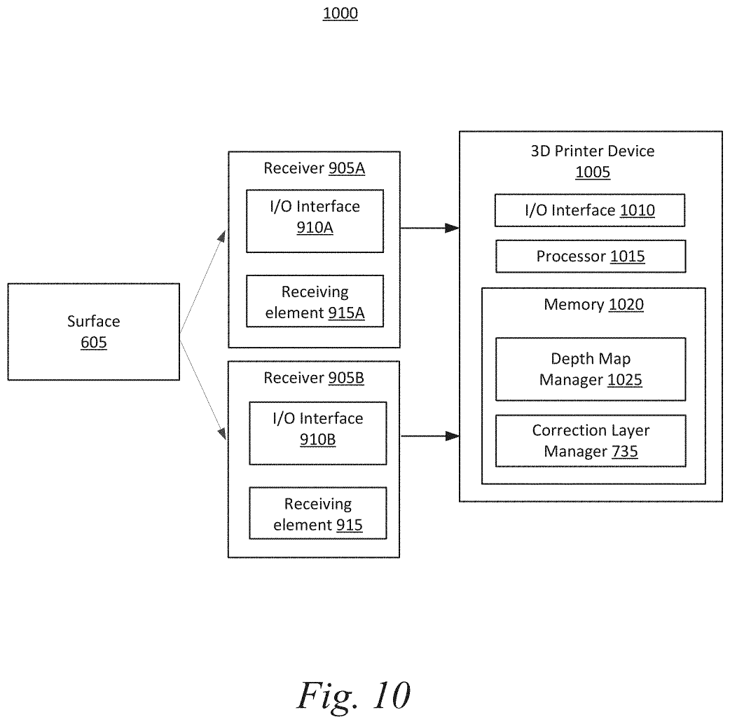

Referring now to FIG. 10, FIG. 10 shows an example embodiment of a system 1000 for applying a correction layer using parallax techniques. The system 1000 includes a receiver 905A, a receiver 905 B, and a 3D printer device 1005.

The receivers 905A and 905B (sometimes generally referred to as receivers 905) may each include, for example, a camera, such as a CCD camera. The receivers 905A and 905B may implement lenses, such as macro lenses. The receivers 905A and 905B may be similar, or identical. The receiver 905A may be disposed at a first position, and the receiver 905B may be disposed at a second position. In some embodiments, rather than implementing two receivers 905, the system 1000 may implement a single receiver and may be configured to move the receiver from the first position to the second position. For example, a single receiver 905 may be attached to a carriage of a 3D printer that include printheads. Thus the camera can be moved without adding moving pats to the system, and the system can perform imaging while the 3D printer is printing. Such a receiver 905 can be used to detect blown nozzles or ink clogs of the 3D printer, and to accurately print on top of existing objects placed in a printbed (e.g., to accurately dispose a correction layer on a 3D printed object).

The receivers 905 can include at least one processor and a memory, e.g., a processing circuit. The memory can store processor-executable instructions that, when executed by processor, cause the processor to perform one or more of the operations described herein. The processor 645 may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language, and may be received from the 3D printer device 1005.

The receivers 905 may include an I/O interface 910 configured to transmit data to the 3D printer device 1005 (e.g., via a network or a wired connection). The receivers 905 may includ3e receiving element 915 configured to receive light, and to responsively generate an analog signal (e.g., using photovoltaic elements). The receivers 905 may include circuitry to process the analogue signal to generate a digital signal including data regarding the received light, and may send the digital signal to the 3D printer device 1005 via the I/O interface 910. The receivers 905 may be disposed at a known distance from each other.

The 3D printer device may include an I/O interface 1010, a processor 1015, and a memory 1020 storing processor-executable instructions. The processor-executable instructions may include programs, applications application programming interfaces, libraries, or other computer software for performing processes described herein. The memory 1020 may include, but is not limited to, electronic, optical, magnetic, or any other storage or transmission device capable of providing processor with program instructions. The memory 1020 may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®. For example, the memory 1020 may include a depth map manager 1025 and the correction layer manager 735 (described above in reference to FIG. 7).

The I/O interface 1010 may be configured to communicate with the I/O interface 910 of either of the receivers 905, and may thus be configured to receive data related to light received by the receivers 905, including first image data from the receiver 905A and second image data from the receiver 905B. The processor 1015 may include a microprocessor, an application-specific integrated circuit (ASIC), a field-programmable gate array (FPGA), etc., or combinations thereof. The processor 1015 may be configured to execute any of the processor-executable instructions stored in the memory 1020, including any of the depth map manager 1025 and the correction layer manager 735. The I/O interface may be configured, for example, to transmit instructions to one or more other computing devices operating in conjunction with the 3D printer device 1005, such as a 3D printer manufacturing or printing a 3D object. The instructions transmitted by the I/O interface may be configured to modify or apply additional layers to the printing process of the 3D printer.

The depth map manager 1025 may receive the first image data and the second image data, and may determine a depth of the surface 605 at a plurality of locations using parallax techniques. For example, the depth manager 1025 may calculate an amount of shift of a feature of the surface 605 detected in both the first image data and the second image data, relative to a background or backdrop. The depth map manager may determine, based on the known distance between the receivers 905 (which value may be stored in the memory 1020) and using parallax techniques, a distance of the detected feature from one or both of the receivers 905. Thus, a depth map of the surface 605 may be determined by the depth map manager 1025. The depth of the surface 605 may be further determined using the distance of each receiver 905 from the surface 605. In some implementations, the distances described herein can be stored in the memory 1020, or may be programmed or received by the 3D printer device 1005 in the form of instructions.

The correction layer manager 735 may be configured as described above with respect to FIG. 7, and may use the depth map determined by the depth map manger 1025 as a profile of the surface 605 to determine and apply the correction layer. For example, the correction layer manager 735 can determine a difference profile indicating a difference at a plurality of points (or a single point) between the profile of the surface 605 and a specified height or depth indicated by the specifications. The correction layer manager 735 can determine a correction layer that compensates, at least in part, for the determined difference. For example, the correction layer manager 735 may determine that a height of one or more portions of the surface 605 is lower than it should be (according to the specifications, received by the 3D printer device 705), and the correction layer manager 735 may determine a correction layer that has a thickness corresponding to (e.g. substantially equal to) the determined difference. In some embodiments, the correction layer manager 735 may determine that a height of one or more portions of the surface 605 is higher than it should be (according to the specifications), and the correction layer manager 735 may determine a correction layer that raises other portions of the surface 605 to mitigate a height difference between the overly-high portions and the other portions of the surface 605. The correction layer manager 735 may generate instructions for a 3D printer to implement or apply the correction layer. As discussed above, the 3D printer may be part of the 3D printer device, or may be a separate device, in which case the 3D printer device 1005 may transmit instructions to the 3D printer (e.g., via the I/O interface 1010) to generate the correction layer.

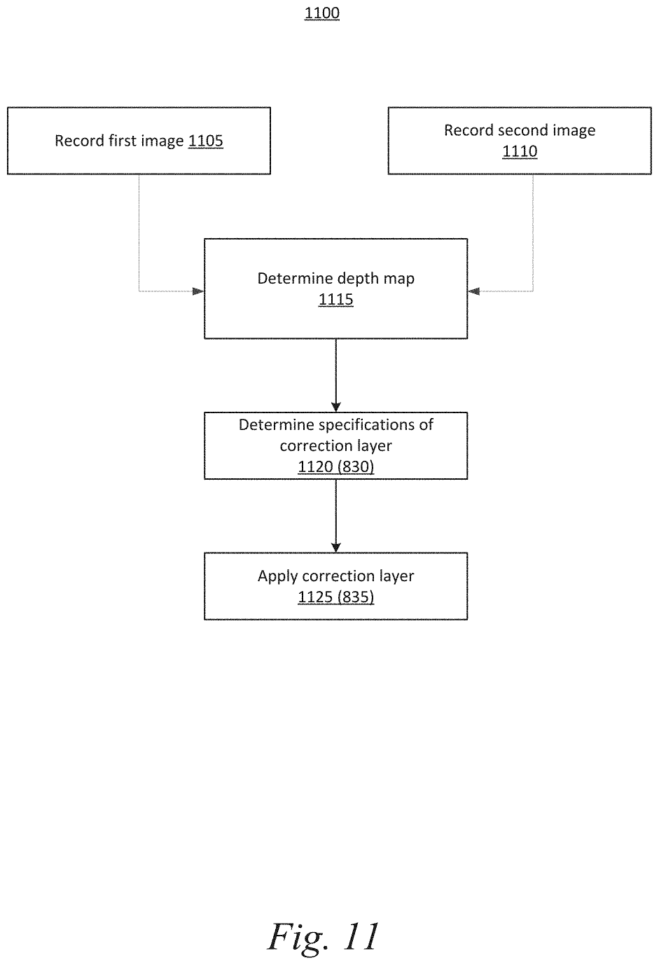

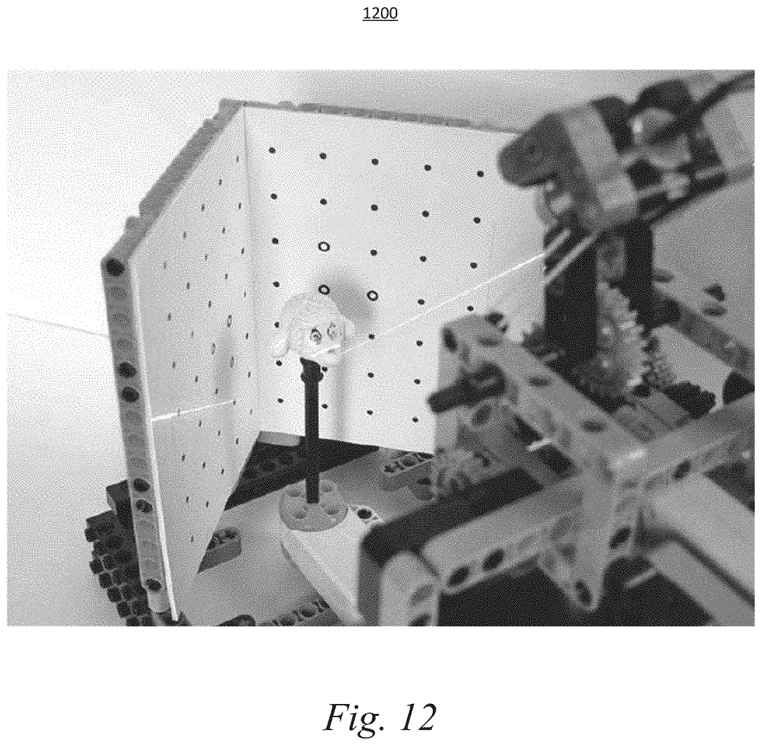

Referring now to FIG. 11, FIG. 11 shows an example embodiment of a method 1100 for applying a correction layer using parallax techniques. The method 1100 includes processes recording first image data of a surface 1105, recording second image data of a surface 1110, determining a depth map of the surface 1115, determining the specifications of the correction layer 1120, and applying the correction layer 1125. The method 1100 can be carried out, for example, by the 3D printing device 1005, or any other components of the system 1000 described herein above in reference to FIG. 10.

In the process 1105, the receiver 905A records first image data of a surface 605 of a 3D object being printed based on received light. The receiver 905A may transmit the first image data to the 3D printer 1005 via the I/O interface 910A of the receiver 905A. In the process 1110, the receiver 905B records second image data of the surface 605 based on received light. The receiver 905B may transmit the second image data to the 3D printer 1005 via the I/O interface 910B of the receiver 905B. Images may be captured in a variety of formats, such as RAW image format or a compressed image format (e.g., JPEG, etc.). Other image formats may also be used, such as bitmap, portable network graphics (PNG), or other image formats. The image may include metadata that indicates features or characteristics of the image, which may be used by the 3D printer device 1005 to perform one or more calculations of the angle of incidence, the height map, the profile, or the depth map, as described herein.

In process 1115, the depth map manager 1020 of the 3D printer device 1005 may determine a depth map of the surface 605 based on the first image data and the second image data, using parallax techniques. For example, the depth map manager 1025 may determine a depth of the surface 605 at a plurality of locations using parallax techniques. For example, the depth manager 1025 may calculate an amount of shift of a feature of the surface 605 detected in both the first image data and the second image data, relative to a background or backdrop. The depth map manager may determine, based on the known distance between the receivers 905 (which value may be stored in the memory 1020) and using parallax techniques, a distance of the detected feature from one or both of the receivers 905. Thus, a depth map of the surface 605 may be determined by the depth map manager 1025. The depth of the surface 605 may be further determined using the distance of each receiver 905 from the surface 605. In some implementations, the distances described herein can be stored in the memory 1020, or may be programmed or received by the 3D printer device 1005 in the form of instructions.

The process 1120 may include determining specifications of a correction layer for the 3D printed object using the depth map as a profile of the surface 605. The process 1120 may be similar to the process 830 described above with reference to FIG. 8. For example, the correction layer manager 735 can determine a difference profile indicating a difference at a plurality of points (or a single point) between the profile of the surface 605 and a specified height or depth indicated by the specifications. The correction layer manager 735 can determine a correction layer that compensates, at least in part, for the determined difference. For example, the correction layer manager 735 may determine that a height of one or more portions of the surface 605 is lower than it should be (according to the specifications of an object, received by the 3D printer device 1005), and the correction layer manager 735 may determine a correction layer that has a thickness corresponding to (e.g. substantially equal to) the determined difference. In some embodiments, the correction layer manager 735 may determine that a height of one or more portions of the surface 605 is higher than it should be (according to the specifications), and the correction layer manager 735 may determine a correction layer that raises other portions of the surface 605 to mitigate a height difference between the overly-high portions and the other portions of the surface 605. The correction layer manager 735 may generate instructions for a 3D printer to implement or apply the correction layer. As discussed above, the 3D printer may be part of the 3D printer device, or may be a separate device, in which case the 3D printer device 1005 may transmit instructions to the 3D printer (e.g., via the I/O interface 1010) to generate the correction layer.

The process 1125 may include applying the determined correction layer to the 3D printed object. The process 1125 may be similar to the process 835 described above with reference to FIG. 8. As discussed above, the 3D printer may be part of the 3D printer device, or may be a separate device, in which case the 3D printer device 1005 may transmit instructions to the 3D printer (e.g., via the I/O interface 1010) to generate the correction layer. Such instructions may be inserted between or among existing instructions to print or manufacture a 3D object. The instructions may override an existing 3D printing process, such that a new layer is inserted in the process. The instructions specifying layers subsequent to the correction layer may be modified to compensate for the material added by the correction layer.

Thus, the method 1100 may provide for determine and applying a correction layer for accurate 3D printing. The method 1100 may be more accurate and faster than comparative techniques described herein, and may involve using less computing resources. The method 1100 can be carried out by any of the processing or computing devices described herein.

FIG. 12 shows a quality control system 1200 for a 3D printing system. The techniques described herein can be used to determine a depth of a 3D printed object (e.g., using the depicted laser line scanner), and to ensure that the 3D printed object meets specifications (e.g., is within a manufacturing tolerance of specifications). Such a quality control system 1200 can be implemented in a variety of settings, including a factory automation line.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed is:

1. A system for determining and applying a correction layer to a three-dimensional object undergoing a 3D printing process, comprising:
an emitter device configured to illuminate a surface portion of an object undergoing a three-dimensional (3D) printing process;
a receiver device configured to receive a light input reflected from the surface portion of the object and generate an image using the light input;
a 3D printer device including one or more processors and a memory, wherein the 3D printer device is configured to:
create a profile for the surface portion of the object using an angle of incidence and an image received from the receiver device;
determine a difference between a first point of the profile for the surface portion and a corresponding point in a specification of the object undergoing the 3D printing process;
generate instructions to apply a correction layer using the difference between the first point of the profile for the surface portion and the corresponding point in the specification of the object.

2. The system of claim 1, wherein the emitter device is further configured to:
emit light at the first angle;
receive instructions from the 3D printer device to emit light at a second angle; and
emit light at the second angle in response to executing the instructions received from the 3D printer device.

3. The system of claim 1, wherein the emitter device is further configured to:
receive instructions from the 3D printer device to emit light at a plurality of angles in a specified order; and
emit light at the plurality of angles in the specified order in the instructions.

4. The system of claim 1, wherein the emitter device is configured to emit light of a wavelength that is greater than the visible spectrum; and
wherein the receiver device is configured to receive the light at the wavelength that is greater than the visible spectrum.

5. The system of claim 1, wherein the receiver device is further configured to:
generate an analog signal in response to receiving the light input reflected from the surface portion of the object;
calculate an angle of incidence of the light reflected from the surface portion of the object using the analog signal; and
provide the angle of incidence to the 3D printer device.

6. The system of claim 5, wherein the receiver device further comprises a photovoltaic element, and wherein the analog signal is received from the photovoltaic element.

7. The system of claim 1, wherein the 3D printer device is further configured to:
calculate a height value of the surface portion of the object undergoing the 3D printing process using a distance between the emitter device and the receiver device; and
create the profile of the surface portion of object using the height value.

8. The system of claim 1, wherein the 3D printer device is further configured to:
determine a vector between an illuminated point on the surface of the object and the receiver device; and
create the profile for the surface portion of the object using the vector.

9. The system of claim 1, wherein the 3D printer device is further configured to:
detect a location of a laser line in the image received from the receiver device using a plurality columns of pixels in the image;
determine the angle of incidence relative to the receiver using the location of the laser line in the image received from the receiver device.

10. The system of claim 1, wherein the 3D printer device is further configured to:
determine that the height of a first point of the profile for the surface portion is less than a height of the corresponding point in the specification of the object; and
generate the instructions to apply the correction layer such that the correction layer has a thickness that corresponds to the difference in the height of the first point and the height of the corresponding point.

11. A method of determining and applying a correction layer to a three-dimensional (3D) object undergoing a 3D printing process, comprising:
illuminating, by a three-dimensional (3D) printer device comprising an emitter device and a receiver device, a surface portion of an object undergoing a 3D printing process;
receiving, by the 3D printer device, a light input reflected from the surface portion of the object and generating an image using the light input;
creating, by the 3D printer device, a profile for the surface portion of the object using an angle of incidence and an image generated by the 3D printer device;
determining a difference between a first point of the profile for the surface portion and a corresponding point in a specification of the object undergoing the 3D printing process;
generating, by the 3D printer device, instructions to apply a correction layer using the difference between the first point of the profile for the surface portion and the corresponding point in the specification of the object.

12. The method of claim 11, wherein illuminating the surface portion further comprises:
emitting, by the 3D printer device, light at the first angle; and
emitting, by the 3D printer device, light at the second angle in response to executing the instructions received from the 3D printer device.

13. The method of claim 11, wherein illuminating the surface portion further comprises:
receiving, by the 3D printer device, instructions to emit light at a plurality of angles in a specified order; and
emitting, by the 3D printer device, light at the plurality of angles in the specified order in the instructions.

14. The method of method 11, wherein illuminating the surface portion further comprises emitting, by the 3D printer device, light of a wavelength that is greater than the visible spectrum; and
wherein receiving the light input further comprises receiving light at the wavelength that is greater than the visible spectrum.

15. The method of claim 11, further comprising:
generating, by the 3D printer device, an analog signal in response to receiving the light input reflected from the surface portion of the object; and
calculating, by the 3D printer device, an angle of incidence of the light reflected from the surface portion of the object using the analog signal.

16. The method of claim 15, wherein the 3D printer device further comprises a photovoltaic element, and further comprising receiving, by the photovoltaic element of the 3D printer device, the analog signal.

17. The method of claim 11, wherein determining the profile for the surface portion of the object further comprises:
calculating, by the 3D printer device, a height value of the surface portion of the object undergoing the 3D printing process using a distance between the emitter device and the receiver device; and
determining, by the 3D printer device, the profile of the surface portion of object using the height value.

18. The method of claim 11, wherein determining the profile for the surface portion of the object further comprises:
determining, by the 3D printer device, a vector between an illuminated point on the surface of the object and the receiver device of the 3D printer device; and
generating, by the 3D printer device, the profile for the surface portion of the object using the vector.

19. The method of claim 11, further comprising:
detecting, by the 3D printer device, a location of a laser line in the image using a plurality columns of pixels in the image;
determining, by the 3D printer device, the angle of incidence relative to the receiver device of the 3D printer device using the location of the laser line in the image.

20. The method of claim 11, further comprising:
determining, by the 3D printer device, that the height of a first point of the profile for the surface portion is less than a height of the corresponding point in the specification of the object; and
generating, by the 3D printer device, the instructions to apply the correction layer such that the correction layer has a thickness that corresponds to the difference in the height of the first point and the height of the corresponding point.
